(19) United States
(12) Patent Application Publication
(10) Pub. No.: US 2006/0162644 A1
(43) Pub. Date: Jul. 27, 2006

(54) Light reflector of a guardrail for a road

(76) Inventor: Kwang-chul Choi, Gyeongsangnamdo (KR)

Correspondence Address: GREENBLUM & BERNSTEIN, P.L.C., 1950 ROLAND CLARKE PLACE, RESTON, VA, 20191, US

(21) Appl. No.: 10/563,951

(22) PCT Filed: Jul. 9, 2004
(86) PCT No.: PCT/KR04/01683

§ 371 Date: Jan. 6, 2006

(30) Foreign Application Priority Data
Jul. 11, 2003 (KR) 10-2003-0047352

(51) Int. Cl. G01N 31/22

(52) U.S. Cl. 116/200

(57) ABSTRACT

A light reflector (delineator) of a guardrail for a road having a mirror like light reflecting surface formed on a reverse trapezoidal valley of a light reflecting body, and front and rear ends of the reverse trapezoidal valley attached with a high brightness light reflecting tape or coated with a fluorescent paint. The light reflector is mounted on a guardrail for a road, a stone marker for a road, a guardrail for a bridge, and a breast wall of a road, so as that the light from a headlight of a vehicle is reflected by the light reflecting surfaces of the reverse trapezoidal valley and the light reflecting tape or the fluorescent paint in the night, thus entire the light reflector is brighter.

### TECHNICAL FIELD

The present invention relates to a light reflector of a guardrail for a road, and more particularly to a light reflector, in which a mirror like light reflecting surface is formed on a reverse trapezoidal valley of a light reflecting body, and front and rear ends of the reverse trapezoidal valley are attached with a high brightness light reflecting tape or coated with a fluorescent paint, being mounted on a guardrail for a road, a stone marker for a road, a guardrail for a bridge, and a breast wall of a road, so as that the light from headlights of a vehicle is reflected by the light reflecting surfaces of the reverse trapezoidal valley and the light reflecting tape or the fluorescent paint in the night, and thus the entire light reflector is brightened.

### BACKGROUND ART

Generally, a guardrail 1 mounted on a road, as shown in FIG. 1, is installed with light reflectors 2, disclosed in Korean Utility Model Publication No. 1996-0006168 (Publication Date: Jul. 22, 1996), filed in the Korean Intellectual Property Office by this applicant and now registered. The light reflector 2 reflects light emitted from headlights of a vehicle driving on the road at night, helping the driver to confirm the position where the guardrail is mounted on the road and the road conditions. Thus, the driver can drive the vehicle safely.

The light reflector 2 used as described above is made by attaching light reflecting tape to lateral sides of an installing unit 3 by bending a steel plate in a triangular pipe. The light from the headlights of the vehicle on the road in the night is reflected by the high brightness light reflecting tapes 4, so that the driver sees the reflected light and drives the vehicle safely.

However, since the light from the vehicle is reflected by only the light reflecting tape 4, only an amount of light corresponding to the amount of light projected to reflecting tape 4 is reflected. Since the high brightness light reflecting tape 4 is so expensive, the light reflecting tape 4 is cut into small pieces and attached to the triangular pipe. For this reason, the driver cannot see the light reflected by the light reflecting tapes 4 well. Moreover, due to static electricity generated around the high brightness light reflecting tape 4, dust or smoke generated around the road is attached on a surface of the light reflecting tape 4, so that the amount of light reflected from the light reflecting tape is greatly reduced.

### DISCLOSURE

### Technical Problem

Therefore, the present invention has been made in view of the above problems, and it is an object of the present invention to provide a light reflector, in which a mirror like light reflecting surface is formed on a reverse trapezoidal valley of a light reflecting body, and front and rear ends of the reverse trapezoidal valley are attached with a high brightness light reflecting tape or coated with a fluorescent paint, wherein the light reflector is mounted on a guardrail for a road, a stone marker for a road, a guardrail for a bridge, or a breast wall of a road, so as that the light from the headlights of a vehicle is reflected by the light reflecting surfaces of the reverse trapezoidal valley and the light reflecting tape or the fluorescent paint in the night, thus the entire light reflector is brightened, wherein a plurality of light reflectors are formed with the inserting protrusion and the inserting recess at both sides and are straightly coupled to each other without torsion by the inserting protrusion and the inserting recess, and the well-known transparent static electricity preventive materials coated on a transparent cover prevent the static electricity from accumulating in the guardrail, so that the transparent cover may be kept clear by preventing the dust or smoke from attaching to the transparent cover and the reflected light from the light reflector can be more bright.

### Technical Solution

In accordance with an aspect of the present invention, the above and other objects can be accomplished by the provision of a light reflector for a road guardrail including a light reflecting body formed with a reverse trapezoidal valley inside of the light reflecting body in a longitudinal direction, and formed with inclined surfaces for closing front and rear ends of the reverse trapezoidal valley at the front and rear ends, mirror like light reflecting plates formed on the bottom surface and lateral sides of the reverse trapezoidal valley and plated by the well-known mirror surface plating, light reflecting tape attached on the inclined surfaces or fluorescent paint coated on the inclined surfaces, and a transparent cover, installed on an upper side of the light reflecting body, for covering a space defined by the reverse trapezoidal valley and the front and rear inclined surfaces.

Preferably, the reverse trapezoidal valley is provided with a plurality of protrusions protruded from the bottom surface thereof. The light reflecting body is provided with an inserting protrusion at one side thereof, and is formed with an inserting recess, in which the inserting protrusion of another adjacent light reflector is inserted, at the other side of the light reflecting body. An upper surface of the transparent cover is coated with a well-known transparent static electricity preventive materials.

### Advantageous Effects

The light reflector is formed with a mirror like light reflecting surface on a reverse trapezoidal valley of a light reflecting body, and a high brightness light reflecting tape attached on a front and rear ends of the reverse trapezoidal valley or a fluorescent paint coated on front and rear ends of the reverse trapezoidal valley. The light reflector is mounted on a guardrail for a road, a stone marker for a road, a guardrail for a bridge, and a breast wall of a road, so that the light from headlights of a vehicle is reflected by the light reflecting surfaces of the reverse trapezoidal valley and the light reflecting tape or the fluorescent paint in the night, thus entire the light reflector is brightened.

A plurality of light reflectors are formed with the inserting protrusion and the inserting recess at both sides and are straightly coupled to each other without torsion by the inserting protrusion and the inserting recess. The well-known transparent static electricity preventive materials is coated on a transparent cover, and prevents static electricity from accumulating in the guardrail, so that the transparent cover may be kept clean by preventing dust or smoke from attaching to the transparent cover. Thus, the reflected light from the light reflector can be more bright.

### DESCRIPTION OF THE DRAWINGS

The above and other objects, features and other advantages of the present invention will be more clearly understood from the following detailed description taken in conjunction with the accompanying drawings, in which:

FIGS. 1A and 1B are a perspective view and a side view illustrating a guardrail in which a light reflector according to a conventional art is mounted to;

FIG. 2 is an exploded perspective view showing a light reflector according to the present invention produced by cutting;

FIG. 3 is a front cross sectional view showing an assembled light reflector in FIG. 2;

FIG. 4A is a side cross sectional view illustrating the assembled light reflector in FIG. 2;

FIG. 4B is a side cross sectional view illustrating an assembled light reflector according to another example of the light reflector in FIG. 2;

FIGS. 5A and 5B are front cross sectional views illustrating a light reflector according to another embodiment of the present invention;

FIG. 6 is a partial cross section view illustrating that adjacent light reflectors according to still another embodiment of the present invention are coupled to each other by fitting;

FIG. 7A is a front elevation view illustrating that the light reflector according to the present invention is installed on a guardrail; and

FIG. 7B is a side cross sectional view illustrating that the light reflector according to the present invention is installed on a guardrail of a bridge.

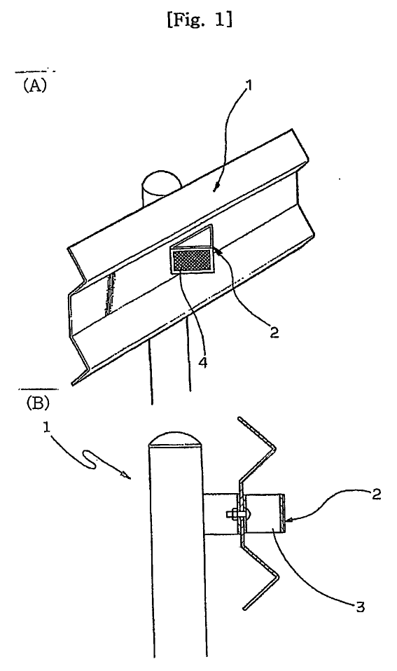

### DESCRIPTION OF REFERENCE NUMERALS

1. guardrail
2. light reflector
3. installing unit
4. light reflecting tape
5. light reflecting body
6. reverse trapezoidal valley
7, 7a. inclined plates
8. light reflecting plate
9, 9a. light reflecting tape or fluorescent paint
10. transparent cover
11, 11a. protrusions
12. light reflector
13. inserting protrusion
14. inserting recess
15. horizontal rail
16. vertical support
17. road
18. static electricity preventive materials

### BEST MODE

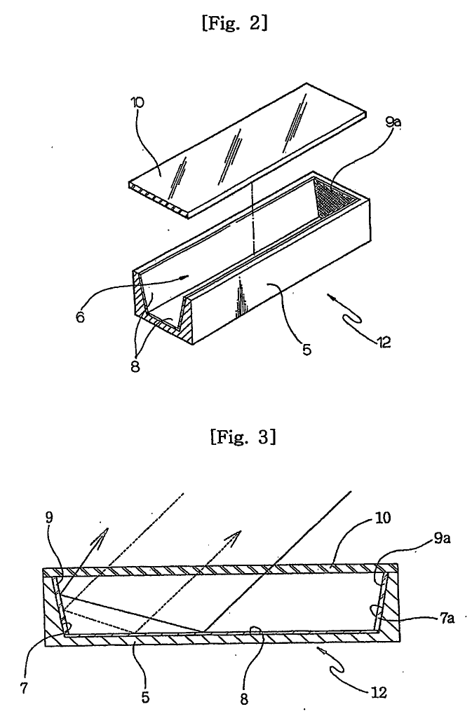

A light reflector of the present invention to achieve the above object of the present invention will be described in detail by referring FIGS. 2 to 7 as follows.

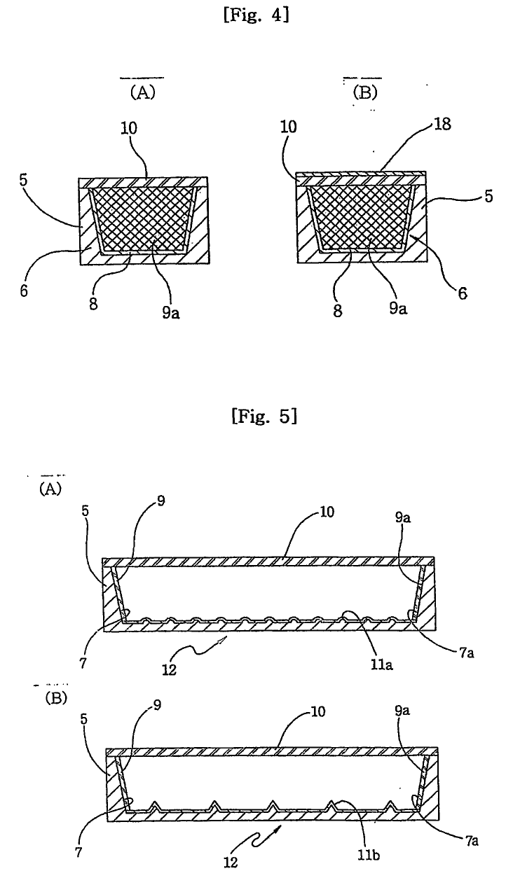

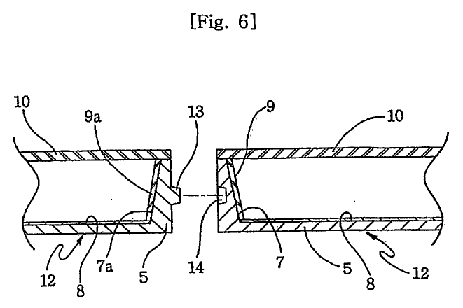

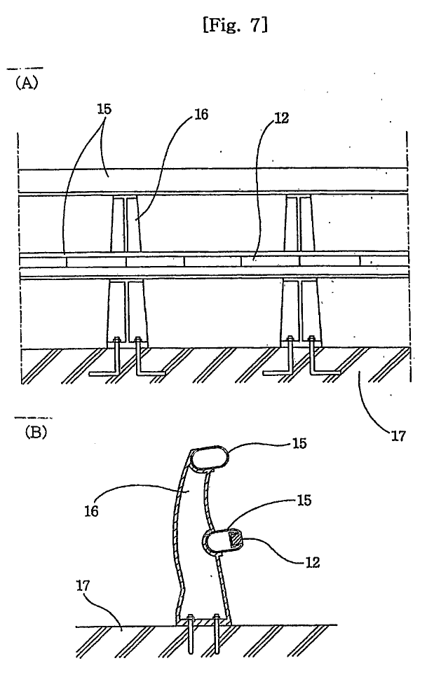

FIG. 2 is an exploded perspective view showing a light reflector according to the present invention produced by cutting, FIG. 3 is a front cross sectional view showing an assembled light reflector in FIG. 2, FIG. 4A is a side cross sectional view illustrating the assembled light reflector in FIG. 2, FIG. 4B is a side cross sectional view illustrating an assembled light reflector according to another example of the light reflector in FIG. 2, FIGS. 5A and 5B are front cross sectional views illustrating a light reflector according to another embodiment of the present invention, FIG. 6 is a partial cross section view illustrating that adjacent light reflectors according to still another embodiment of the present invention are coupled to each other by fitting, FIG. 7A is a front elevation view illustrating that the light reflector according to the present invention is installed on a guardrail, and FIG. 7B is a side cross sectional view illustrating that the light reflector according to the present invention is installed on a guardrail of a bridge.

The light reflector according to the present invention installed on the guardrail for a road, as shown in FIGS. 2 to 4, includes a body 5, inclined sections 7 and 7a, and light reflecting plates 8. The body 5 is formed with a reversed trapezoidal-shaped valley 6 inside the body 6 in a longitudinal direction. The inclined surfaces 7 and 7a block front and rear sides of the valley 6, and are formed at the front and rear sides of the valley 6, respectively. The light reflecting plates 8 are installed at a bottom surface and both lateral surfaces of the trapezoidal valley 6. The light reflecting plates 8 have mirror surfaces plated by the well-known mirror-surface plating. The inclined surfaces 7 and 7a are attached with a light reflecting tape or coated with fluorescent paints 9 and 9a. The light reflecting tape and the fluorescent paint are equally effective as the light reflecting plates 8.

The body 5 is molded by ejecting synthetic resin. After forming the trapezoidal-shaped valley 6 and the inclined surfaces 7 and 7a at the front and rear sides of the valley 6, the bottom surface and the lateral surfaces of the valley 6 are plated by the well-known chromium plating or the mirror surface plating so as to form the mirror like light reflecting plates 8.

Instead of the synthetic resin body 5 being provided with the mirror like reflecting plate 8 formed by the reverse trapezoidal shaped valley 6 plated by the well-known chromium plating or mirror surface plating, a metal plate such as a stainless steel plate having a smooth surface sufficient to reflect light, may be bent to form the body 5. In other words, the stainless steel plate may be bent to form the reverse trapezoidal shaped valley 6, and the valley 6 may be provided with the inclined surfaces 7 and 7a at the front and rear sides. In this case, since the stainless steel plate has a smooth surface like a mirror surface and is bent to form the light reflecting body 5, there is no need to attach the light reflecting plates 8 on or to plate chromium onto the bottom surface and both lateral surfaces of the reverse trapezoidal shaped valley 6.

Moreover, the light reflecting body 5 is provided with a transparent cover 10 at an upper side thereof. The cover 10 covers the space defined by the reverse trapezoidal shaped valley 6 and the front and rear inclined surfaces 7 and 7a. As another embodiment of the present invention, as shown in FIG. 4A, the surface of the transparent cover 10 is coated with static electricity preventive materials 18. As is well-known, the static electricity preventive materials 18 contain a transparent ceramic element for preventing static electricity.

FIGS. 5A and 5B show a light reflector according to another embodiment of the present invention. As shown in the drawing, the light reflector according to another embodiment of the present invention is provided with a plurality of protrusions 11a and 11b. The protrusions 11a and 11b protrude from the bottom surface of the reverse trapezoidal shaped valley 6. A light reflecting plate 8 is formed entire bottom surface containing the protrusions 11a and 11b.

The protrusions 11a in FIG. 5A are formed on the bottom surface of the reverse trapezoidal valley 6 and have a small-sized semi-spherical shape. The protrusions 11b in FIG. 5B are formed on the bottom surface of the reverse trapezoidal valley 6 and have a triangular cross section. It may be formed on the bottom surface of the small-sized spherical shaped protrusions 11a together with the triangular protrusions 11b so as to enhance the light reflection efficiency.

### MODE FOR INVENTION

FIG. 6 shows a light reflector according to second embodiment of the present invention. The light reflector according to second embodiment of the present invention, as shown in FIG. 7, includes a light reflecting body 12 formed with an inserting protrusion 13 at a side thereof and an inserting recess 14, in which the inserting protrusion 12 of another adjacent light reflecting body 12 is inserted, at the other side thereof. When the light reflectors 12 of this embodiment of the present invention are installed on horizontal rails 15 of the guardrail 1, one light reflector 12 is coupled with another adjacent light reflector 12 by inserting the inserting protrusion of one light reflector 12 into the inserting recess 14 of another adjacent light reflector 12.

The above-mentioned structure of the light reflector 12 according to second embodiment of the present invention, that is, the light reflector 12 having the inserting protrusion 13 and the inserting recess 14 can be applied to the light reflector 12 as shown in FIGS. 2 to 4, and the light reflector 12 according to second embodiment of the present invention as shown in FIGS. 5A and 5B.

Hereinafter, the operation of the light reflector with the above-mentioned structure will be described in detail by referring to FIGS. 2 to 7.

As shown in FIG. 7, a guardrail 1 includes a plurality of vertical supports 16 installed on a road 17 at predetermined intervals, and a plurality of horizontal rails 15 sequentially mounted on the vertical supports 17. Each horizontal rail 15 is formed with an inserting hole (Not shown) in which the light reflector 12 is inserted and mounted on. A plurality of light reflectors 12 are inserted into the inserting holes, so that the light reflectors 12 are horizontally connected to adjacent light reflectors 12.

As described above, since the light reflectors 12 are horizontally mounted on the guardrail 1, the light from the headlights of a vehicle traveling on the road in the night is projected onto the light reflectors 12.

If the light of the headlights of the vehicle is projected onto the light reflectors 12, the light is transmitted through the transparent cover 10 obliquely as depicted by the dotted line and the solid line in FIG. 3. The light is reflected on the high brightness reflecting tape 9 attached to the inclined surface 7a in a manner for closing ends of the reverse trapezoidal valley 6 so as to brighten the reflecting tape 9 as well as to brighten the mirror like light reflecting plate 8 provided on the bottom surface of the reverse trapezoidal valley 6. Thus, due to the reflected light, the yellow light of the light reflecting tape 9 appears brighter. The reflected light, projected onto and reflected by the light reflecting plates 8 of the reverse trapezoidal valley 6, does not reach the light reflecting tape 9, and is reflected as white light together with the light reflected from the bottom surface and the lateral surfaces. Thus, these reflected lights look like emitting from entire space of the reverse trapezoidal valley 6.

In second embodiment shown in FIGS. 5A and 5B, since the bottom surface of the reverse trapezoidal valley 6 is provided with the semi-spherical protrusions 11a or the triangular cross sectional protrusions 11b, the light transmitted through the transparent cover 10 and reflected by the light reflecting plates 8 is diffusely reflected by the protrusions 11a and 11b. Thus, the diffusely reflected light is brighter.

As described above, the light is diffusely reflected by the protrusions 11a and 11b of the bottom surface. The diffusely reflected light is repeatedly reflected by the light reflecting plates of the reverse trapezoidal valley 6 and the lateral side light reflecting plates 8, and the light reflecting tapes 9. For this reason, the light from the headlights of the vehicle is brighter and the driver can drive the vehicle safe.

Moreover, according to the light reflector 12, since the upper surface of the transparent cover 10 is coated with the static electricity preventive materials 18 containing the well-known transparent ceramic paint, the transparent cover 10 prevent static electricity from accumulating in the guardrail 1. Thus, dust or smoke is prevented from attaching on the transparent cover 10, so that the transparent cover 10 is always kept clear as well as the amount of the light transmitted the transparent cover 10 increases more and more. Therefore, the light reflector 12 is brighter.

Further, since the light reflector 12 of the present invention is formed with the inserting protrusion 13 and the inserting recess 14 in which the inserting protrusion 13 of an adjacent light reflector 12 is inserted, a plurality of the light reflectors 12 are coupled to each other straightly and are mounted on the guardrail 1 by inserting the inserting protrusion 13 into the inserting recess 14. The light reflectors 12 mounted on the guardrail 1 are not easily detached from the guardrail 1.

Although only the reverse trapezoidal valley 6 of the light reflecting body 5 has been described in the embodiments of the present invention, a quadrangular-shaped valley, a semi-circular valley, or a V-shaped valley may be formed in the valley. Even in this case, the effect and operation of the light reflector may be the same as the light reflector having the reverse trapezoidal valley.

### INDUSTRIAL APPLICABILITY

The light reflector of the present invention is mounted on the guardrail of a road, and reflects the light from the headlight of the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A light reflector for a road guardrail, comprising:
a light reflecting body formed with a reverse trapezoidal valley inside of the light reflecting body in a longitudinal direction, and formed with inclined surfaces that close front and rear ends of the reverse trapezoidal valley at the front and rear ends;
mirror like light reflecting plates formed on a bottom surface and lateral sides of the reverse trapezoidal valley and plated by the well-known mirror surface plating;
a light reflecting tape attached on the inclined surfaces or fluorescent paint coated on the inclined surfaces; and
a transparent cover, installed on an upper side of the light reflecting body, that covers a space defined by the reverse trapezoidal valley and the front and rear inclined surfaces.

2. The light reflector as set forth in claim 1, wherein the reverse trapezoidal valley is provided with a plurality of protrusions protruded from the bottom surface thereof.

3. The light reflector as set forth in claim 1, wherein the light reflecting body is provided with an inserting protrusion at a side thereof, and is formed with an inserting recess, in which the inserting protrusion of adjacent another light reflector is inserted, at the other side of the light reflecting body.

4. The light reflector as set forth in claim 1, wherein an upper surface of the transparent cover is coated with a well-known transparent static electricity preventive materials.

5. The light reflector as set forth in claim 3, wherein an upper surface of the transparent cover is coated with a well-known transparent static electricity preventive materials.

6. The light reflector as set forth in claim 2, wherein the light reflecting body is provided with an inserting protrusion at a side thereof, and is formed with an inserting recess, in which the inserting protrusion of adjacent another light reflector is inserted, at the other side of the light reflecting body.

7. The light reflector as set forth in claim 2, wherein, an upper surface of the transparent cover is coated with a well-known transparent static electricity preventive materials.

8. The light reflector as set forth in claim 6, wherein an upper surface of the transparent cover is coated with a well-known transparent static electricity preventive materials.
